(19) United States
(12) Patent Application Publication
(10) Pub. No.: US 2022/0235886 A1
(43) Pub. Date: Jul. 28, 2022

(54) CONNECTOR CAPABLE OF STABLY CONNECTING FLUID PIPELINE

(71) Applicant: LI CHUNG PLASTICS INDUSTRY CO., LTD., TAICHUNG CITY (TW)

(72) Inventor: Tony HSU, TAICHUNG CITY (TW)

(21) Appl. No.: 17/464,501

(22) Filed: Sep. 1, 2021

(30) Foreign Application Priority Data
Jan. 27, 2021 (TW) 110201029
Apr. 22, 2021 (TW) 110204487

(51) Int. Cl. F16L 19/02; F16L 15/04; F16L 15/06

(52) U.S. Cl. CPC F16L 19/0218; F16L 19/0206; F16L 15/06; F16L 15/04

(57) ABSTRACT

A connector for connecting a fluid pipeline includes an inner socket, which is a columnar body having a channel, and both ends defined as a first end and a second end. The inner socket has a guide portion, an attaching portion, an anti-leak portion and a connecting portion sequentially arranged on the outer side from the first end to the second end; the first end is socketed into an end of a tube by the guide portion; the attaching portion is a spiral concave groove on an outer side of the inner socket for attaching an inner side of the tube; the anti-leak portion is between an end of the tube and the connecting portion for sealing an opening of the tube; and the connecting portion is between the anti-leak portion and the second end and exposed from the tube for connecting another connecting portion of another connector.

### FIELD OF INVENTION

The present invention relates to a connector, and more particularly to the connector capable of stably connecting a fluid pipeline.

### BACKGROUND OF INVENTION

### Description of the Related Art

A pipeline such as a rubber tube or a plastic tube used for transmitting a fluid usually requires a connector to connect a device or another pipeline, and the pipeline is cut into an appropriate length according to actual requirements and then a connector is installed to an end of the pipeline.

With reference to FIG. 10 for a conventional connector, an end of a tube 91 such as a rubber tube or a plastic tube is passed and sheathed to the interior of a metal sheath 92, and then an end of a hollow columnar plug 93 is passed into the tube 91, and a mechanical equipment or a hydraulic equipment applies a tightening pressure to the metal sheath 92 to tightly clamp the tube 91 between the metal sheath 92 and the plug 93, and a connecting portion 931 such as an external thread disposed at the other end of the plug 93 is provided for connecting an internal thread of another connector.

With reference to FIG. 11 for another conventional connector, the difference between this connector and the previous one as shown in FIG. 10 resides on that the connecting portion 931 at the other end of the plug 93 has a nut, and an end of the nut is pivotally connected to the plug 93 for connecting an external thread of another connector.

The aforementioned conventional connector requires a mechanical equipment or hydraulic equipment that applies a tightening pressure to the metal sheath 92 to achieve a watertight or airtight effect.

In the aforementioned conventional connector, full inspection must be performed, in terms of quality control, to ensure the watertight or airtight effect of the plug 93 and the tube 91 due to the problems of the connection strength of the plug 93 that is connected to the tube 91 or the tolerance of the tightening equipment. It is not just laborious and time-consuming only, but also involves a tightening process that will reduce the space of the channel of the plug 93.

Further, the inventor of the present invention has invented an improved structure, wherein a circular member is formed and extended in a transverse direction from an inner side of an end of the metal sheath 92 for abutting and connecting a surface of the circular member by an outer end surface of the tube 91, and the inner side of the circular member further has an internal thread, and an end of the plug 93 has a triangular external thread. By the internal thread and the external thread, a wrench can be used to rotate the plug 93, and the plug 93 can be guided into the tube 91 more easily, and the external thread of the plug 93 can be used to embedding and engaging the inner side of the tube 91. In general, if the inner diameter of the tube 91 is 6.5 mm, the outer diameter of the external thread of the plug 93 must be approximately 9.6 mm to achieve the embedment or engagement with a watertight or airtight effect. The material used for embedding and engaging the tube 91 is generally not longer than 0.5 mm, and the tensile strength of the plug 93 is approximately 60 kg.

However, in this improved structure having the metal sheath 92 with the internal thread and the plug 93 with the external thread, the connection strength of the plug 93 that is embedded and engaged with the tube 91 still does not reach the desired resistance strength. In addition, when the triangular external thread of the plug 93 enters into the tube 91, they are often misaligned, thus resulting in poor embedment and engagement.

### SUMMARY OF THE INVENTION

Therefore, it is a primary object of the present invention to provide a connector capable of stably connecting a fluid pipeline, and the connector can be installed to a tube or a device instantly and conveniently.

Another objective of the present invention is to provide a connector capable of stably connecting a fluid pipeline, and the connector can achieve a watertight or airtight effect easily.

A further objective of the present invention is to provide a connector capable of stably connecting a fluid pipeline, and the connector can lower the assembling cost effectively.

To achieve the aforementioned and other objectives, the present invention discloses a connector capable of stably connecting a fluid pipeline, and the connector comprises an inner socket which is a columnar body having a channel and both ends defined as a first end and a second end respectively, and an outer side of the inner socket has a guide portion, an attaching portion, an anti-leak portion and a connecting portion sequentially arranged from the first end to the second end; wherein, the first end of the inner socket is passed and socketed into an end of a tube by the guide portion; the attaching portion is a spiral concave groove disposed on an outer side of the inner socket for attaching an inner side of the tube; the anti-leak portion is disposed between an end of the tube and the connecting portion for sealing an opening of the tube to stop leaking a fluid of the tube; and the connecting portion is disposed between the anti-leak portion and the second end of the inner socket and exposed from the tube, and the connecting portion is provided for coupling another connecting portion of another connector.

The above and other objects, features and advantages of the invention will become apparent from the following detailed description taken with the accompanying drawings.

### BRIEF DESCRIPTION OF THE DRAWINGS

FIG. 1 is a perspective view showing an assembly of a tube and an outer socket in accordance with a first preferred embodiment of the present invention;

FIG. 2 is an exploded view of FIG. 1;

FIG. 3 is a cross-sectional view of Section 3-3 of FIG. 1;

FIG. 4 is a perspective view of a second preferred embodiment of the present invention;

FIG. 5 is a perspective view showing an assembly of a tube and an outer socket in accordance with a third preferred embodiment of the present invention;

FIG. 6 is an exploded view of FIG. 5;

FIG. 7 is a cross-sectional view of Section 7-7 of FIG. 5;

FIG. 8 is a schematic view showing the connector of FIG. 5 without the design of a hexagonal profile but having a screw for assembling a tube and an outer socket;

FIG. 9 is an exploded view showing an assembly of a tube and an outer socket in accordance with a fourth preferred embodiment of the present invention;

FIG. 10 is a perspective view showing an assembly of a tube and a metal sheath of a conventional connector; and

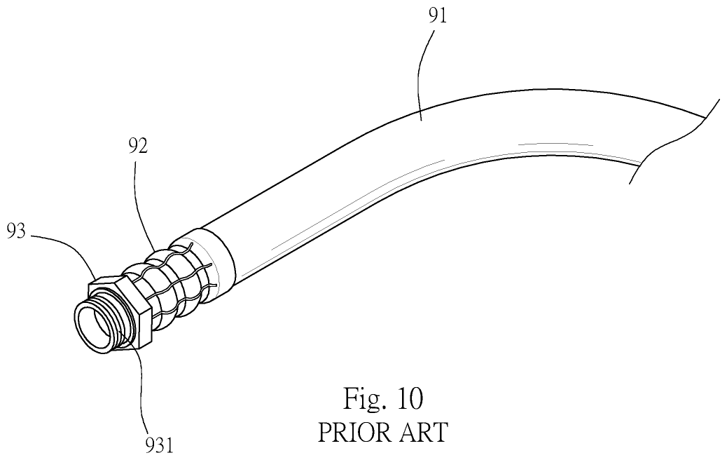

FIG. 11 is another perspective view showing an assembly of a tube and a metal sheath of a conventional connector.

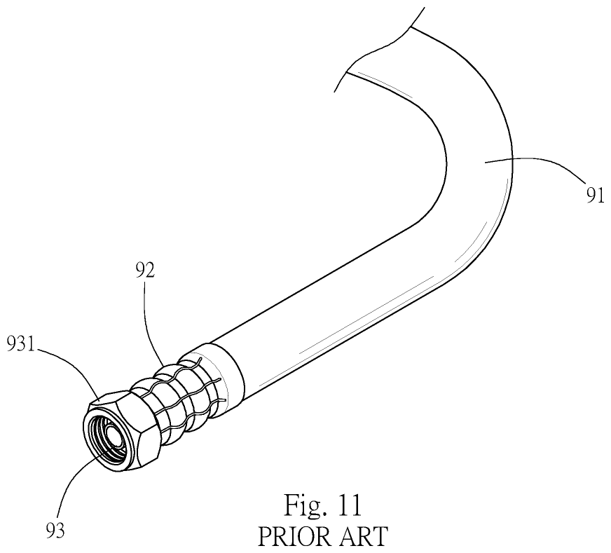

### DESCRIPTION OF THE PREFERRED EMBODIMENTS

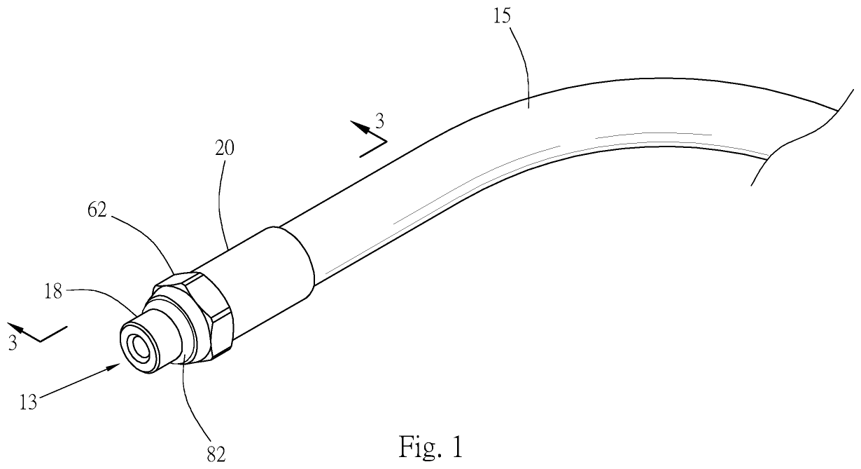

With reference to FIGS. 1 to 3 for a connector capable of stably connecting a fluid pipeline in accordance with the first embodiment of the present invention, the connector includes an inner socket 10 which is a columnar body having a channel and both ends defined as a first end 11 and a second end 13 respectively, and the outer side of the inner socket 10 has a guide portion 12, an attaching portion 14, an anti-leak portion 16 and a connecting portion 18 sequentially arranged from the first end 11 to the second end 13.

The first end 11 of the inner socket 10 is partially socketed into an end of a tube 15 by the guide portion 12, and the guide portion 12 is a conical body with a size of the outer side of the inner socket 10 decreasing in a direction from a side of the attaching portion 14 to the first end 11. By the conical guide portion 12, the inner socket 10 has be better degree of freedom to pass and sheath to the interior of the tube 15, wherein the tube 15 can be a rubber tube or a plastic tube.

The attaching portion 14 is a spiral concave groove formed on the outer side of the inner socket 10. One end of the attaching portion 14 is neighbor to the guide portion 12. When the inner socket 10 is rotatably passed and sheath to the interior of the tube 15, the spiral concave groove of the attaching portion 14 is provided for embedding, attaching and connecting an inner side of the tube 15 to achieve the effect of engaging the inner socket 10 with the tube 15. Particularly, if the size of the attaching portion 14 is greater than the size of the internal space of the tube 15, then the present invention further has a locking effect, wherein the spiral concave groove of the attaching portion 14 can be a trapezoidal thread or a rectangular thread.

The anti-leak portion 16 is formed by an appropriate part extending in a direction from the other end of the attaching portion 14 to the second end 13, and the anti-leak portion 16 is a columnar body with an outer side in a shape corresponding to the shape of the internal space of the tube 15. When the inner socket 10 is rotatably passed and sheathed to the interior of the tube 15, the anti-leak portion 16 is provided for attaching and connecting the inner side of the tube 15 to seal an opening of the tube 15, so as to achieve the effect of preventing a fluid in the tube 15 from leaking from a surrounding of the inner socket 10.

The connecting portion 18 is disposed between the anti-leak portion 16 of the inner socket 10 and the second end 13 and exposed from the tube 15, and the connecting portion 18 is provided for connecting another connecting portion of another connector (not shown in the figures). When the connecting portion 18 is an external thread, another connecting portion of another connector can be an internal thread such as a nut. Further, an anti-leakage washer 82 can be installed between the connecting portion 18 and the inner socket 10 for sealing an opening of another connector to achieve the anti-leakage effect.

In FIGS. 1 to 3, the connector capable of stably connecting a fluid pipeline of the present invention further includes an outer socket 20 which is a columnar body having a channel and socketed and attached to the outer side of an end of the tube 15, so that the tube 15 is at least attached between the outer socket 20 and the attaching portion 14 of the inner socket 10, and the outer socket 20 is provided for strengthening the assembly structure of the inner socket 10 and the tube 15.

In the connector capable of stably connecting a fluid pipeline as shown in FIGS. 1 to 3, a hexagonal member 62 is extended from the outer side of the inner socket 10 and between the anti-leak portion 16 and the connecting portion 18, so that the present invention can use a wrench to apply a force to the hexagonal member 62 in order to install the connector to the tube 15 instantly and conveniently.

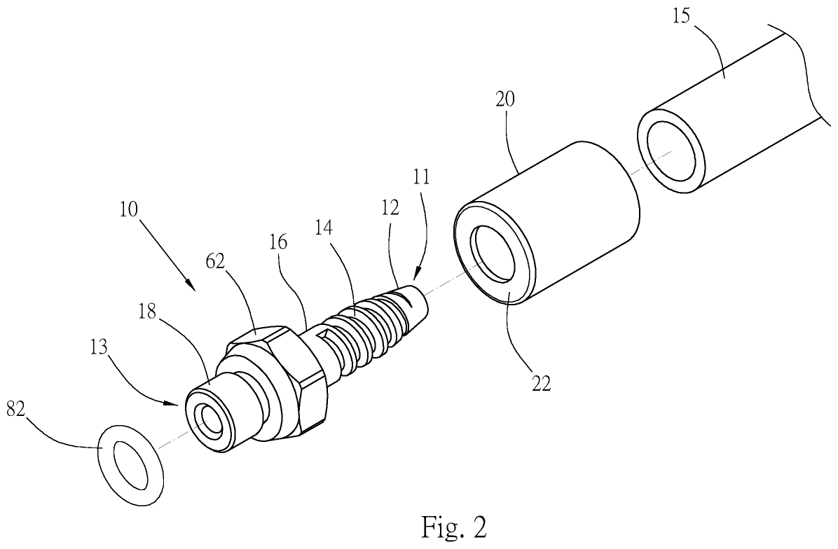

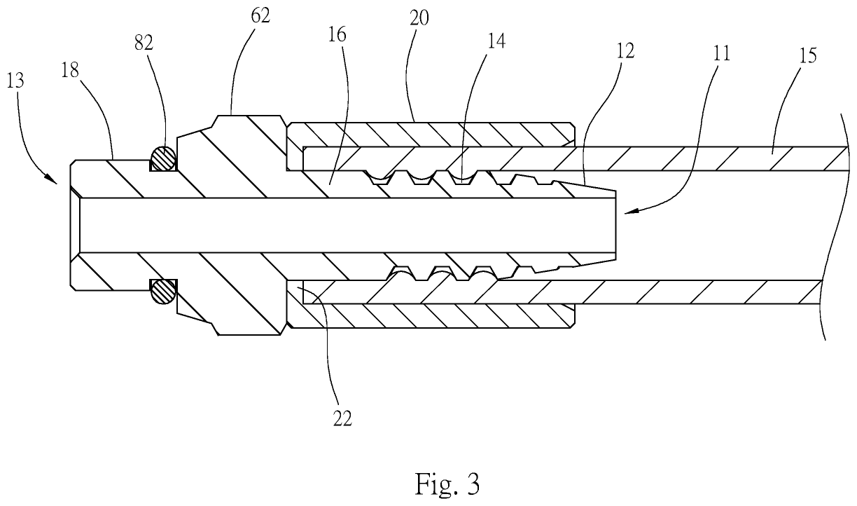

In the connector capable of stably connecting a fluid pipeline of the present invention as shown in FIGS. 2 and 3, a circular member 22 is extended in a transverse direction from an inner side of an end of the outer socket 20, so that the outer end surface of the tube 15 can abut and connect a side of the circular member 22 to provide better structural strength and assembly positioning.

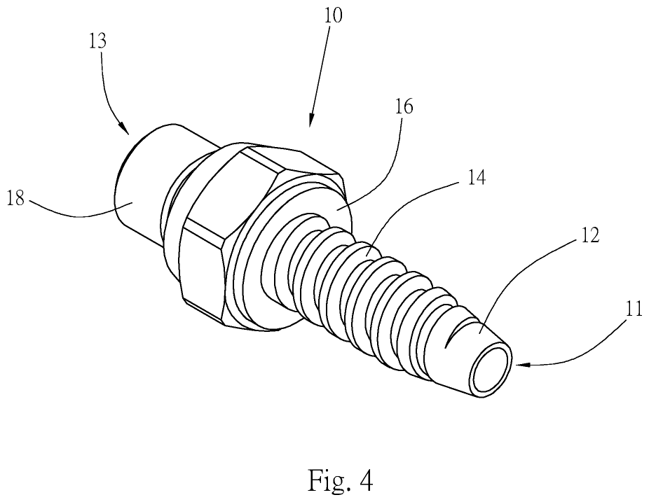

With reference to FIG. 4 for a connector capable of stably connecting a fluid pipeline in accordance with the second embodiment of the present invention, there is no columnar body extending in a direction from the other end of the attaching portion 14 towards the second end 13, but there is an anti-leakage washer sheathe to form the anti-leak portion 16 for sealing the opening of the tube 15.

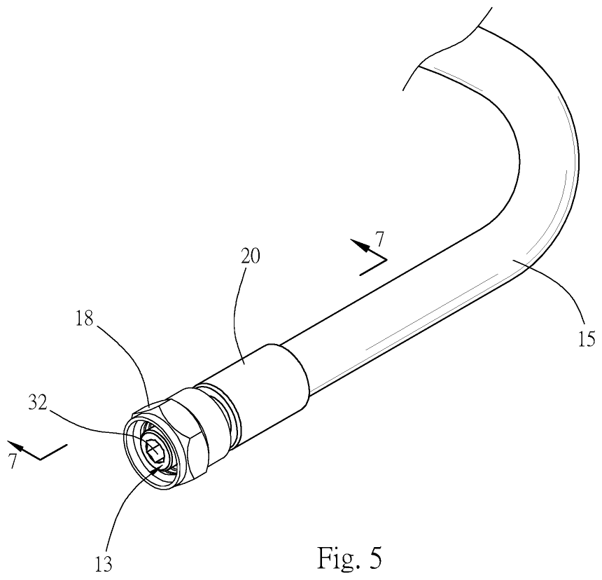

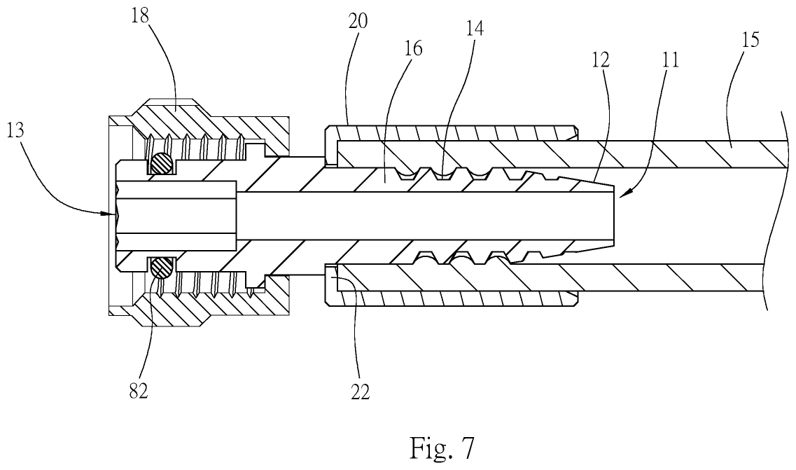

With reference to FIGS. 5 to 7 for a connector capable of stably connecting a fluid pipeline in accordance with the third embodiment of the present invention, the connecting portion 18 is a columnar body having a channel, and the connecting portion 18 has an end pivotally connected to the inner socket 10 and the other end of the connecting portion 18 has an internal thread for connecting another connector, and another connecting portion of another connector can be an external thread. The connecting portion 18 of the third embodiment of the present invention is a nut.

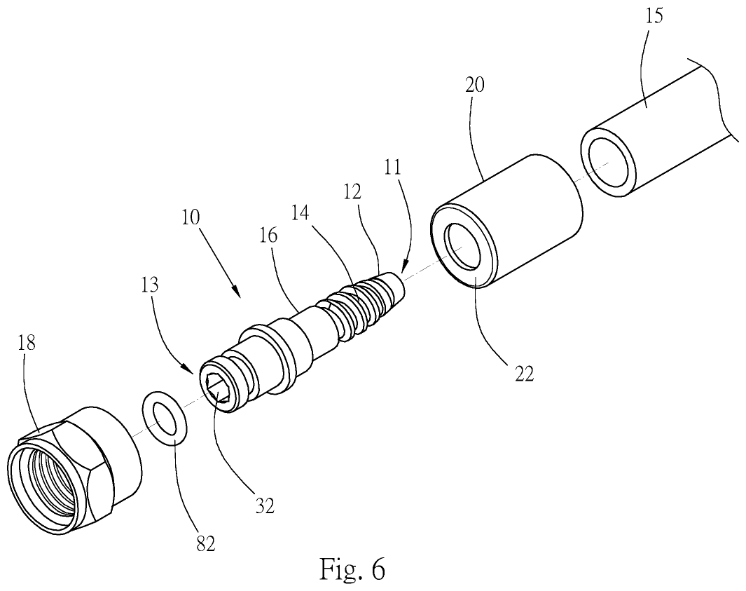

In the connector capable of stably connecting a fluid pipeline of the present invention as shown in FIGS. 5 and 6, a hexagonal profile 32 is designed on the inner side of the second end 13 of the inner socket 10, and the present invention can use an Allen wrench to apply a force to the hexagonal profile 32 in order to install the connector to the tube 15 instantly and conveniently.

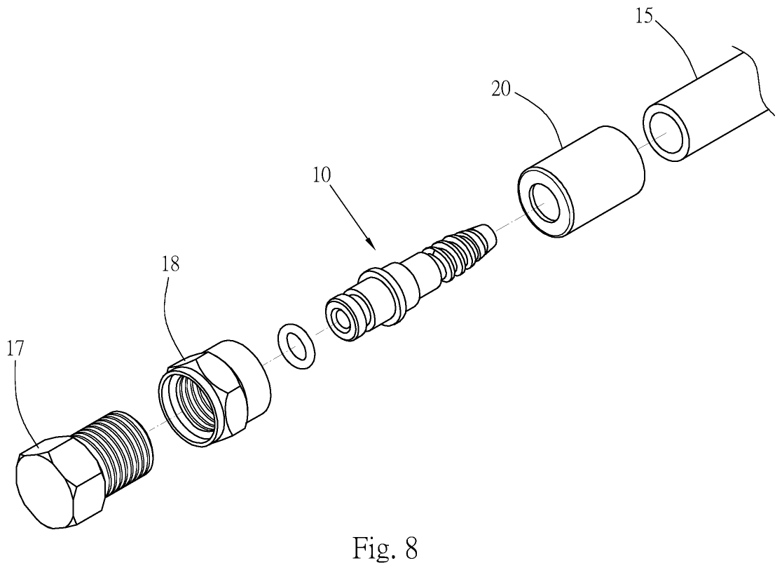

With reference to FIG. 8, if the third embodiment of the present invention does not have the design of the hexagonal profile 32, then the present invention can be used together with a screw 17 to lock the connecting portion 18, so as to link the inner socket 10 to install the connector to the tube 15 instantly and conveniently.

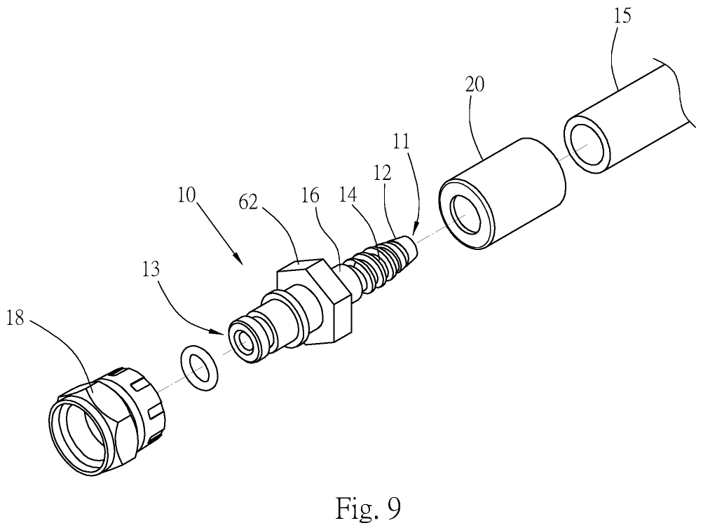

With reference to FIG. 9 for the fourth embodiment of the present invention, if the third embodiment of the present invention does not have the design of the hexagonal profile 32, then a hexagonal member 62 can be designed on the outer side of the inner socket 10 and between the anti-leak portion 16 and the connecting portion 18, so that the present invention can use a wrench to apply a force to the hexagonal member 62 to install the connector to the tube 15 instantly and conveniently.

In the present invention, the spiral concave groove of the attaching portion 14 can be designed as a trapezoidal thread or a rectangular thread to significantly enhance the connection strength for the embedment and engagement of the inner socket 10 with the inner side of the tube 15, and the material of the inner socket 10 embedding and engaging with the tube 15 can be up to 0.75˜1.0 mm, and the tensile strength of the inner socket 10 is approximately 120˜200 kg, so that the present invention can almost or completely achieve the watertight and airtight effect. In addition, the spiral concave groove of the inner socket 10 having an outer diameter of only 8 mm is provided for passing through the tube 15 having an inner diameter of 6.5 mm, so that the present invention can achieve the aforementioned effects. On the other hand, when the spiral concave groove of the inner socket 10 is passed through the tube 15, the inner socket 10 has a self-guiding effect to prevent misalignment. The present invention further provides the design of the anti-leak portion 16, so that the connector of the present invention can achieve the watertight or airtight effect more effectively and reliably without requiring any tightening mechanical equipment or requiring the installation of the outer socket 20, and the invention does not require full inspection for the quality control.

As to the manufacture of the connector of the present invention, the manufacturing process can be divided into different assembly processes to effectively achieve a manufacture with division of labor, and the present invention has a better production efficiency to effectively lower the manufacturing cost.

What is claimed is:

1. A connector capable of stably connecting a fluid pipeline, comprising:
an inner socket, being columnar body having a channel, and both ends defined as a first end and a second end respectively, the inner socket having a guide portion, an attaching portion, an anti-leak portion and a connecting portion disposed on an outer side thereof and arranged sequentially in a direction from the first end to the second end;
wherein, the first end of the inner socket is passed and socketed into an end of a tube by the guide portion;
the attaching portion is a spiral concave groove disposed on an outer side of the inner socket for attaching an inner side of the tube;
the anti-leak portion is disposed between an end of the tube and the connecting portion for sealing an opening of the tube to stop leaking a fluid of the tube; and
the connecting portion is disposed between the anti-leak portion and the second end of the inner socket and exposed from the tube, and the connecting portion is provided for coupling another connecting portion of another connector.

2. The connector capable of stably connecting a fluid pipeline according to claim 1, further comprising an outer socket which is a columnar body having a channel and socketed and attached to an outer side of an end of the tube, so that the tube is at least attached between the outer socket and the attaching portion of the inner socket.

3. The connector capable of stably connecting a fluid pipeline according to claim 1, wherein the guide portion is a conical body with a size of the outer side of the inner socket decreasing in a direction from a side of the attaching portion to the first end.

4. The connector capable of stably connecting a fluid pipeline according to claim 2, wherein the guide portion is a conical body with a size of the outer side of the inner socket outer side decreasing in a direction from a side of the attaching portion to the first end.

5. The connector capable of stably connecting a fluid pipeline according to claim 1, wherein the attaching portion is selected from a group consisting of a trapezoidal thread and a rectangular thread.

6. The connector capable of stably connecting a fluid pipeline according to claim 2, wherein the attaching portion is selected from a group consisting of a trapezoidal thread and a rectangular thread.

7. The connector capable of stably connecting a fluid pipeline according to claim 1, wherein the anti-leak portion is selected from a group consisting of a columnar body with an outer side in a shape corresponding to the shape of the internal space of the tube and a first anti-leakage washer.

8. The connector capable of stably connecting a fluid pipeline according to claim 2, wherein the anti-leak portion is selected from a group consisting of a columnar body with an outer side in a shape corresponding to the shape of the internal space of the tube and a first anti-leakage washer.

9. The connector capable of stably connecting a fluid pipeline according to claim 1, wherein the connecting portion is an external thread.

10. The connector capable of stably connecting a fluid pipeline according to claim 2, wherein the connecting portion is an external thread.

11. The connector capable of stably connecting a fluid pipeline according to claim 1, wherein the connecting portion is a columnar body having a channel, and the connecting portion has an end pivotally coupled to the inner socket and the other end having an internal thread for coupling another connector.

12. The connector capable of stably connecting a fluid pipeline according to claim 2, wherein the connecting portion is a columnar body having a channel, and the connecting portion has an end pivotally coupled to the inner socket and the other end having an internal thread for coupling another connector.

13. The connector capable of stably connecting a fluid pipeline according to any one of claim 9, further comprising a second anti-leakage washer installed between the connecting portion and the inner socket for sealing an opening of another connector.

14. The connector capable of stably connecting a fluid pipeline according to any one of claim 10, further comprising a second anti-leakage washer installed between the connecting portion and the inner socket for sealing an opening of another connector.

15. The connector capable of stably connecting a fluid pipeline according to any one of claim 11, further comprising a second anti-leakage washer installed at the second end for sealing an opening of another connector.

16. The connector capable of stably connecting a fluid pipeline according to any one of claim 12, further comprising a second anti-leakage washer installed at the second end for sealing an opening of another connector.

17. The connector capable of stably connecting a fluid pipeline according to any one of claim 1, wherein the inner socket has a hexagonal member extending from an outer side thereof and between the anti-leak portion and the connecting portion, or a hexagonal profile formed on an inner side of the second end of the inner socket.

18. The connector capable of stably connecting a fluid pipeline according to any one of claim 3, wherein the inner socket has a hexagonal member extending from an outer side thereof and between the anti-leak portion and the connecting portion, or a hexagonal profile formed on an inner side of the second end of the inner socket.

19. The connector capable of stably connecting a fluid pipeline according to any one of claim 5, wherein the inner socket has a hexagonal member extending from an outer side thereof and between the anti-leak portion and the connecting portion, or a hexagonal profile formed on an inner side of the second end of the inner socket.

20. The connector capable of stably connecting a fluid pipeline according to any one of claim 7, wherein the inner socket has a hexagonal member extending from an outer side thereof and between the anti-leak portion and the connecting portion, or a hexagonal profile formed on an inner side of the second end of the inner socket.
